(19) United States
(12) Patent Application Publication
(10) Pub. No.: US 2026/0121055 A1
(43) Pub. Date: Apr. 30, 2026

(54) ELECTRODE AND MANUFACTURING METHOD OF ELECTRODE

(71) Applicant: TOYOTA JIDOSHA KABUSHIKI KAISHA, Toyota-shi (JP)

(72) Inventors: Hirokazu TAKEUCHI, Toyota-shi (JP); Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 19/311,507

(22) Filed: Aug. 27, 2025

(30) Foreign Application Priority Data
Oct. 28, 2024 (JP) 2024-188882

(51) Int. Cl. H01M 4/62; H01M 4/02; H01M 4/04; H01M 4/139

(52) U.S. Cl. CPC H01M 4/622; H01M 4/0404; H01M 4/139; H01M 2004/021

(57) ABSTRACT

An electrode includes a current collector and an electrode layer formed on the current collector, the electrode layer containing at least a binder having a swelling degree of 150% or more with respect to an active material and an electrolyte. When the surface side of the electrode layer relative to the center in the thickness direction of the electrode layer is defined as the surface-side portion, and the current collector side is defined as the current-collector-side portion. The electrode layer is configured such that the content concentration of the binder in the surface-side portion is higher than the content concentration of the binder in the current-collector-side portion.

### CROSS-REFERENCE TO RELATED APPLICATION

This application claims priority to Japanese Patent Application No. 2024-188882 filed on Oct. 28, 2024. The disclosure of the above-identified application, including the specification, drawings, and claims, is incorporated by reference herein in its entirety.

### BACKGROUND

### 1. Technical Field

The present disclosure relates to an electrode and a manufacturing method of an electrode.

### 2. Description of Related Art

In recent years, with the rapid proliferation of electronic devices such as personal computers and mobile phones, development of batteries used as power sources therefor has advanced. Furthermore, in the automotive industry, development of batteries used for a hybrid electric vehicle (HEV), a plug-in hybrid electric vehicle (PHEV), or a battery electric vehicle (BEV) has also advanced.

As an example of this type of battery, Japanese Unexamined Patent Application Publication No. 2024-36847 (JP 2024-36847 A) discloses a lithium ion battery including an electrode having a current collector and an electrode layer, and an electrolyte, in which the electrode layer contains a binder having a swelling degree of 120% or more with respect to the electrolyte.

JP 2024-36847 A proposes a lithium ion battery in which an electrode layer contains a highly swelling binder having a swelling degree of 120% or more with respect to an electrolyte. This battery exhibits a high peel strength during a manufacturing process of the battery, but a low peel strength during a disassembling process of the battery, resulting in excellent recyclability.

### SUMMARY

In a case where an electrode layer is provided by a wet method, an electrode in which an electrode layer is provided on a current collector is manufactured by coating an electrode paste containing at least an active material and a binder onto the current collector and drying the electrode paste. In such a manufacturing method of the electrode, migration that is a phenomenon in which the binder segregates toward a surface side of a coating film may occur during drying of the coating film made from the electrode paste.

The electrode in which the migration of the binder has occurred in the electrode layer has the binder unevenly distributed toward the surface side of the electrode layer. Therefore, a content concentration of the binder in a portion of the electrode layer on the surface side is higher than a content concentration of the binder in a portion of the electrode layer on the current collector side.

However, in the technique disclosed in JP 2024-36847 A, the ion permeability of the binder is insufficient, resulting in an increase in ion resistance during charging and discharging. In particular, when a binder having insufficient ion permeability is unevenly distributed toward the surface side of the electrode layer, the movement of lithium ions is likely to be hindered in the portion of the electrode layer on the surface side where the content concentration of the binder is relatively high. As a result, there has been a problem that deterioration in battery characteristics, such as high-speed charging and discharging performance, may occur.

The present disclosure has been made in order to solve such a problem, and an object thereof is to provide an electrode and a manufacturing method of an electrode capable of suppressing deterioration in battery characteristics that may occur due to a binder being unevenly distributed toward a surface side of an electrode layer.

An electrode according to the present disclosure includes:
a current collector; and
an electrode layer provided on the current collector, the electrode layer containing at least a binder having a swelling degree of 150% or more with respect to an active material and an electrolyte,
in which, when a portion of the electrode layer on a surface side relative to a center of the electrode layer in a thickness direction is defined as a surface-side portion, and a portion of the electrode layer on a current collector side relative to the center of the electrode layer in the thickness direction is defined as a current-collector-side portion,
the electrode layer has a content concentration of the binder in the surface-side portion that is higher than a content concentration of the binder in the current-collector-side portion.

A manufacturing method of an electrode according to the present disclosure, the manufacturing method includes:
coating, onto a current collector, an electrode paste containing at least a binder having a swelling degree of 150% or more with respect to an active material and an electrolyte to form a coating film on the current collector; and drying the coating film to form an electrode layer,
in which, when a portion of the electrode layer on a surface side relative to a center in a thickness direction of the electrode layer is defined as a surface-side portion, and a portion of the electrode layer on a current collector side relative to the center in the thickness direction of the electrode layer is defined as a current-collector-side portion,
in the drying, migration of the binder occurs in the coating film such that a content concentration of the binder in the surface-side portion becomes higher than a content concentration of the binder in the current-collector-side portion.

According to the present disclosure, it is possible to provide an electrode and a manufacturing method of an electrode capable of suppressing deterioration in battery characteristics that may occur due to a binder being unevenly distributed toward a surface side of an electrode layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an electrode according to the present disclosure;

FIG. 2 is a view for describing a structure of a binder;

FIG. 3 is a graph showing a relationship between a migration index and a mandrel diameter;

FIG. 4 is a graph showing a relationship between a migration index and a mandrel diameter for each electrode for evaluation; and

FIG. 5 is a graph showing a relationship between a migration index and tortuosity for each electrode for evaluation.

### DETAILED DESCRIPTION OF EMBODIMENTS

### Embodiment 1

Hereinafter, embodiments of the present disclosure will be described with reference to the drawings. Note that, the embodiments of the present disclosure are not limited to the following embodiments. The drawings only show a part of the entire disclosure, and many other configurations that are not shown in the drawings are actually included. Further, in order to clarify the explanation, the following description and drawings are appropriately simplified. In the following description, the same or equivalent elements are designated by the same reference numerals, and redundant description will be omitted.

### Electrode

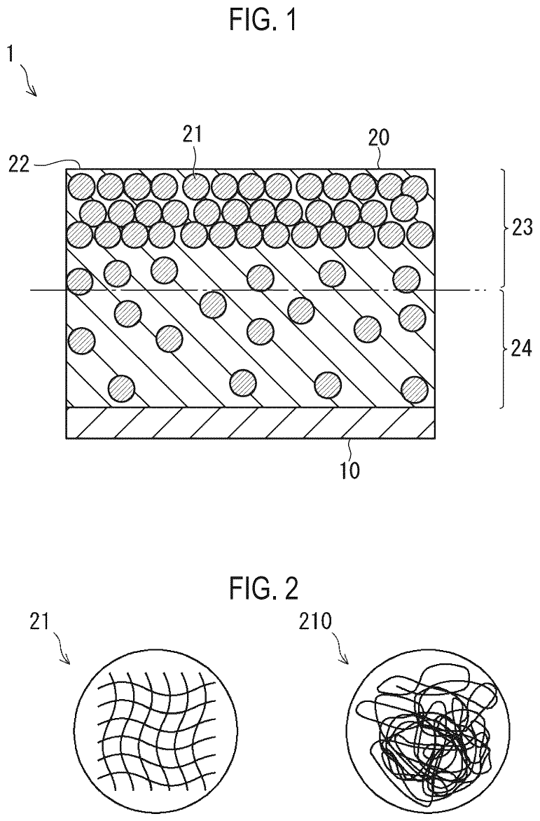

FIG. 1 is a schematic cross-sectional view showing an electrode according to the present disclosure. An electrode 1 according to the present disclosure is used for a battery. The battery is typically a lithium-ion secondary battery. Examples of the application of the battery include power sources for vehicles such as a hybrid electric vehicle (HEV), a plug-in hybrid electric vehicle (PHEV), a battery electric vehicle (BEV), a gasoline automobile, and a diesel automobile. Further, the battery in the present disclosure may be used as a power source of a moving body other than the vehicle (for example, a train, a ship, or an aircraft) or may be used as a power source of an electrical product, such as an information processing device.

The battery includes at least a positive electrode, a negative electrode, and an electrolyte in the form of an electrolytic solution. In the present disclosure, the electrode 1 will be specifically described as an electrode used for a lithium-ion secondary battery. The term “lithium-ion secondary battery” refers to a secondary battery in which lithium ions are used as charge carriers and charging and discharging are realized by movement of charges due to lithium ions between a positive electrode and a negative electrode.

The electrolyte includes, for example, a lithium salt and a solvent. Examples of the lithium salt include inorganic lithium salts such as LiPF₆, LiBF₄, LiClO₄, and LiAsF₆; and organic lithium salts such as LiCF₃SO₃, LiN(SO₂CF₃)₂, LiN(SO₂C₂F₅)₂, and LiC(SO₂CF₃)₃. Examples of the solvent include ethylene carbonate (EC), propylene carbonate (PC), butylene carbonate (BC), dimethyl carbonate (DMC), diethyl carbonate (DEC), and ethyl methyl carbonate (EMC). The solvent may be used alone or in combination of two or more types thereof.

As shown in FIG. 1, the electrode 1 includes a current collector 10 and an electrode layer 20 provided on the current collector 10. The electrode 1 may be a positive electrode, a negative electrode, or both of a positive electrode and a negative electrode. The positive electrode includes a positive electrode current collector and a positive electrode layer provided on the positive electrode current collector. The negative electrode includes a negative electrode current collector and a negative electrode layer provided on the negative electrode current collector.

The current collector 10 may be a positive electrode current collector or a negative electrode current collector. Examples of a material for the positive electrode current collector include SUS, aluminum, nickel, iron, titanium, and carbon. Examples of a material of the negative electrode current collector include SUS, copper, nickel, and carbon. In addition, examples of a shape of the current collector 10 include a foil shape and a mesh shape.

The electrode layer 20 contains at least a binder 21 having a swelling degree of 150% or more with respect to an active material and an electrolyte.

The active material may be a positive electrode active material or may be a negative electrode active material. Examples of the positive electrode active material include a lithium transition metal oxide. Specific examples of the lithium transition metal oxide include LiNiCoMnO₂ (lithium nickel cobalt manganese composite oxide), LiNiO₂ (lithium nickel oxide), LiCoO₂ (lithium cobalt oxide), and LiMn₂O₄ (lithium manganese oxide). Examples of the negative electrode active material include a carbon material. Specific examples of the carbon material include graphite and amorphous carbon.

The active material is, for example, particulate. The particles of the active material are not particularly limited, but an average particle diameter thereof may be, for example, 1 μm or more and 50 μm or less, 2 μm or more and 30 μm or less, or 3 μm or more and 10 μm or less. In the present disclosure, the average particle diameter refers to a particle diameter (D50) corresponding to a cumulative frequency of 50% by volume from a fine particle side having a small particle diameter in a volume-based particle size distribution based on a laser diffraction/light scattering method.

A proportion of the active material in the electrode layer 20 is not particularly limited, but is, for example, 40% by weight or more, and may be 60% by weight or more, or may be 80% by weight or more.

In the present disclosure, the swelling degree of the binder is a weight increase rate of the binder alone when the binder is immersed in an electrolyte at 60° C. for 24 hours, and is specifically a value obtained as follows. Here, for the measurement of the swelling degree, an electrolyte having the same composition as the electrolyte constituting the battery is used.

First, a weight of the binder processed into a sheet shape (weight of the binder before immersion) is measured. Next, the binder is immersed in an electrolyte at 60° C. for 24 hours. A weight of the binder taken out from the electrolyte (weight of the binder after immersion) is measured. The swelling degree of the binder can be determined by the following expression based on a value obtained by dividing the weight of the binder increased after the immersion by the weight of the binder before the immersion. Swelling degree of binder (%)={(Weight of binder after immersion)−(Weight of binder before immersion)}/(Weight of binder before immersion)×100

The electrode layer 20 according to the present disclosure contains the binder 21 having a swelling degree of 150% or more. Hereinafter, the binder 21 having a swelling degree of 150% or more with respect to the electrolyte is also referred to as a “binder 21 having a high swelling degree”.

The binder 21 is usually a polymer. Examples of the binder 21 include a fluoride-based binder such as polyvinylidene fluoride (PVDF), a styrene acrylic-based binder such as a styrene-acrylic acid copolymer (SAR), an acrylic-based binder, and a urethane-based binder. The swelling degree can be adjusted depending on, for example, a molecular structure and a molecular weight of the polymer.

A melting point of the binder 21 is, for example, preferably 100° C. or higher and 150° C. or lower. The melting point of the binder 21 can be determined, for example, by differential scanning calorimetry (DSC) according to the standard specified in JIS K 7121.

The binder 21 is, for example, particulate. An average particle diameter of the particles of the binder 21 may be 10 nm or more and 1,000 nm or less, 50 nm or more and 500 nm or less, or 100 nm or more and 300 nm or less.

A proportion of the binder 21 in the electrode layer 20 is not particularly limited, but is, for example, 0.1% by weight or more, and may be 0.5% by weight or more, or may be 1% by weight or more. On the other hand, the proportion thereof is, for example, 15% by weight or less, and may be 10% by weight or less, or may be 5% by weight or less.

The electrode layer 20 may contain components other than the active material and the binder 21. Hereinafter, components other than the active material and the binder 21 are also referred to as other components. Examples of the other components include a conductive material and a thickener. Examples of the conductive material include a carbon material. Examples of the carbon material include carbon black such as acetylene black (AB), and carbon materials such as carbon nanotubes (CNT) and carbon nanofibers (CNF). Examples of the thickener include celluloses such as carboxymethyl cellulose (CMC) and methyl cellulose (MC).

A proportion of the other components in the electrode layer 20 is not particularly limited, but is, for example, 0.5% by weight or more, and may be 1% by weight or more. On the other hand, the proportion of the other components is, for example, 20% by weight or less, and may be 10% by weight or less.

A broken line in FIG. 1 indicates a center line of the electrode layer 20 in the thickness direction. In the electrode layer 20, a portion of the electrode layer 20 on a surface 22 side relative to the center in the thickness direction is defined as a surface-side portion 23 and a portion of the electrode layer 20 on a current collector 10 side is defined as a current-collector-side portion 24. In this case, in the electrode layer 20, a content concentration of the binder 21 in the surface-side portion 23 is higher than a content concentration of the binder 21 in the current-collector-side portion 24.

The electrode 1, in which the content concentration of the binder 21 in the surface-side portion 23 of the electrode layer 20 is relatively high, exhibits increased flexibility. When the flexibility of the electrode 1 is increased, cracking of the coating film and the electrode layer 20 or peeling from the current collector 10 is less likely to occur.

The electrode layer 20 can be provided by drying a coating film made of an electrode paste containing an active material, the binder 21, and other components as necessary. During drying of the coating film, migration that is a phenomenon in which the binder 21 segregates toward the surface side may occur. The electrode 1 in which the migration of the binder 21 has occurred in the electrode layer 20 has the binder 21 unevenly distributed toward the surface 22 side of the electrode layer 20, so that the content concentration of the binder 21 in the surface-side portion 23 becomes higher than the content concentration of the binder 21 in the current-collector-side portion 24.

Here, FIG. 2 is a view for describing a structure of the binder. On the left side of FIG. 2, one particle of the binder 21 having a swelling degree of 150% or more with respect to an electrolyte is shown. On the right side of FIG. 2, one particle of the binder 210 having a swelling degree of less than 150% with respect to an electrolyte is shown.

Hereinafter, the binder 210 having a swelling degree of less than 150% with respect to the electrolyte is also referred to as a “binder 210 having a low swelling degree”. Examples of the binder 210 include styrene-butadiene rubber (SBR) and an epoxy-based binder.

The binder 210 having a low swelling degree is likely to build an entangled structure of monomer polymer chains in the particles upon swelling. Therefore, the binder 210 having a low swelling degree has fewer gaps in the entangled structure of the polymer chains through which lithium ions can pass. The binder 210 having a low swelling degree has fewer gaps through which lithium ions can pass, thereby making it difficult for lithium ions to pass through the particles.

As described above, the binder 210 having a low swelling degree has low ion permeability. Therefore, in an electrode in which the binder 210 having a low swelling degree is used in the electrode layer instead of the binder 21 having a high swelling degree, the tortuosity of a conduction path of lithium ions in the electrode layer increases, and an ion resistance during charging and discharging increases. In particular, when the binder 210 having a low swelling degree is unevenly distributed toward the surface side of the electrode layer, the movement of lithium ions is likely to be hindered in the portion of the electrode layer on the surface 22 side where the content concentration of the binder 210 is relatively high. As a result, there is a problem that battery characteristics such as high-speed charging and discharging performance may be deteriorated.

On the other hand, the binder 21 having a high swelling degree is more likely to absorb the electrolyte and swell than the binder 210 having a low swelling degree. The binder 21 having a high swelling degree is likely to build a network structure of monomer polymer chains in the particles upon swelling. Therefore, the binder 21 having a high swelling degree has a large number of gaps in the network structure of the polymer chains through which lithium ions can pass. The binder 21 having a high swelling degree has a large number of gaps through which lithium ions can pass, thereby making it easy for lithium ions to pass through the particles.

As described above, the binder 21 having a high swelling degree has high ion permeability. Therefore, in the electrode 1 in which the binder 21 having a high swelling degree is used in the electrode layer 20, the tortuosity of the conduction path of lithium ions in the electrode layer 20 decreases, and thus the ion resistance during charging and discharging is reduced. In such an electrode 1, the movement of lithium ions is smoothly carried out even in the surface-side portion 23 of the electrode layer 20 where the content concentration of the binder 21 is relatively high. As a result, the electrode 1 according to the present disclosure can suppress deterioration in battery characteristics, such as high-speed charging and discharging performance.

The binder 21 is more likely to absorb the electrolyte and swell as the swelling degree is higher. From the viewpoint of reducing the ion resistance, the swelling degree of the binder 21 is preferably as high as possible. On the other hand, from the viewpoint of desirability for use in the electrode 1, the binder 21 preferably has a swelling degree of 200% or less.

Furthermore, in the electrode 1, the binder 21 may have a specific gravity lower than that of the active material. As a result, during drying of the coating film, the binder 21 is likely to segregate toward the surface side in the coating film compared to the active material.

Furthermore, in the electrode 1, a migration index K indicating the uneven distribution of the binder 21 in the thickness direction in the electrode layer 20 is defined as a ratio (K=Bd/Be) of a content concentration Bd of the binder 21 in the surface-side portion 23 to a content concentration Be of the binder 21 in the current-collector-side portion 24. In this case, the migration index K is preferably 1.8 or more.

It is considered that the larger the migration index K, the more unevenly the binder 21 is distributed toward the surface 22 side of the electrode layer 20 in the electrode layer 20. The electrode 1 having the migration index K of 1.8 or more has favorable flexibility, and thus cracking of the coating film and the electrode layer 20 or peeling from the current collector 10 is less likely to occur.

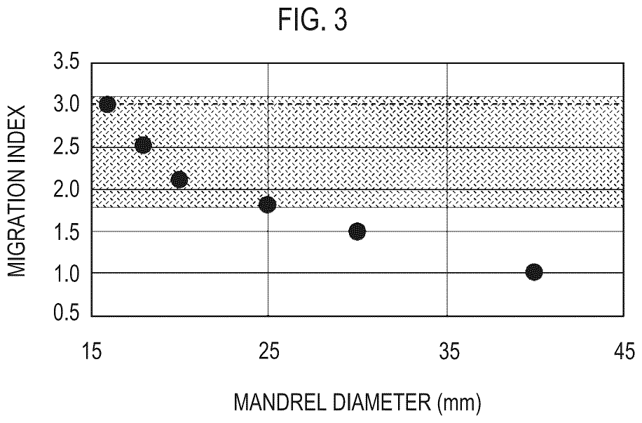

Here, FIG. 3 is a graph showing a relationship between a migration index and a mandrel diameter. The graph shown in FIG. 3 shows the results obtained by performing a bending test (cylindrical mandrel method) according to the test method specified in JIS K 5600-5-1 on a plurality of electrodes of the same composition with various migration indexes K, and obtaining the smallest mandrel diameter at which no cracking occurred.

A vertical axis of the graph shown in FIG. 3 indicates the migration index K. A horizontal axis of the graph shown in FIG. 3 indicates the mandrel diameter (mm). The flexibility increases as the mandrel diameter decreases. The flexibility is preferable for use in the battery when the mandrel diameter is 25 mm or less.

As can be seen from the graph shown in FIG. 3, the larger the migration index K, the smaller the mandrel diameter becomes. That is, the larger the migration index K, the better the flexibility of the electrode. In a case where the migration index K was 1.8 or more, the electrode could be imparted with the preferred flexibility in which the mandrel diameter was 25 mm or less.

### Manufacturing Method of Electrode

The electrode 1 can be manufactured by a manufacturing method of an electrode according to the present disclosure. The manufacturing method of an electrode according to the present disclosure includes coating and drying.

The coating is coating an electrode paste containing at least an active material and the binder 21 onto the current collector 10 to form a coating film on the current collector 10.

The electrode paste is a material for providing the electrode layer 20. The electrode paste contains a solvent in addition to the active material and the binder 21. As the solvent, for example, an organic solvent such as N-methyl-2-pyrrolidone (NMP), water, or a mixed solvent containing water as a main component can be used. The solvent is capable of dispersing or dissolving the binder 21, and is appropriately selected depending on the binder 21 to be used.

The electrode paste can be prepared by mixing the active material, the binder 21, the solvent, and other components as necessary. When mixing these components, for example, a mixing device such as a planetary mixer, a ball mill, a roll mill, a kneader, or a homogenizer can be used.

The electrode paste may be coated using coating devices such as a die coater, comma coater, knife coater, or gravure coater.

The drying is drying the coating film to form the electrode layer 20. In the electrode layer 20, a portion of the electrode layer 20 on a surface 22 side relative to the center in the thickness direction is defined as a surface-side portion 23 and a portion of the electrode layer 20 on a current collector 10 side is defined as a current-collector-side portion 24. In this case, in the drying, migration of the binder 21 occurs in the coating film such that a content concentration of the binder 21 in the surface-side portion 23 is higher than a content concentration of the binder 21 in the current-collector-side portion 24.

For drying the coating film, for example, a drying device such as a hot air drying furnace and an infrared drying furnace can be used. The coating film on the current collector 10 is dried in a state in which the surface of the coating film faces vertically upward. During drying of the coating film, migration occurs as the binder 21 moves toward the surface side along with the movement of the solvent in the coating film, due to the evaporation of the solvent from the surface of the coating film.

In the drying, by causing the migration of the binder 21 in the coating film, the content concentration of the binder 21 having a high swelling degree in the surface-side portion 23 of the electrode layer 20 can be made higher than the content concentration of the binder 21 having a high swelling degree in the current-collector-side portion 24. As a result, the electrode 1 having high flexibility can be obtained.

From the viewpoint of improving the productivity of the electrode 1 by shortening a drying time during drying of the coating film, it is preferable to increase a drying speed in the drying. The drying speed can be controlled by changing, for example, a drying temperature during drying of the coating film.

When the drying speed during drying of the coating film is increased, the migration of the binder 21 in the coating film is more likely to occur, and thus the migration index K increases. The drying speed at which the migration of the binder 21 can occur in the coating film is obtained in advance by experiments, simulations, or the like according to the constituent materials of the electrode paste.

As described above, during drying of the coating film, the flexibility of the electrode 1 can be improved by causing migration of the binder 21. However, as described above, when the binder 210 having a low swelling degree is used instead of the binder 21 having a high swelling degree, in the electrode in which migration of the binder 210 has occurred in the electrode layer, the movement of lithium ions is likely to be hindered in a portion of the electrode layer on the surface side where the content concentration of the binder 210 is relatively high. As a result, there is a problem that battery characteristics such as high-speed charging and discharging performance may be deteriorated.

On the other hand, in the manufacturing method of the electrode 1 according to the present disclosure, the binder 21 having a high swelling degree is used. Therefore, in the electrode 1 in which the migration of the binder 21 has occurred in the electrode layer 20, the movement of lithium ions is smoothly carried out even in the surface-side portion 23 of the electrode layer 20 where the content concentration of the binder 21 is relatively high. As a result, the manufacturing method of the electrode 1 according to the present disclosure can suppress deterioration in battery characteristics such as high-speed charging and discharging performance.

Hereinafter, the present embodiment will be described in more detail with reference to Examples, but the present embodiment is not limited thereto.

### Production of Electrode for Evaluation

### Example 1

### 1. Coating

First, the following materials were prepared to produce an electrode for evaluation.
Active material: artificial graphite (average particle diameter: 5 μm to 30 μm)
Binder: SAR having a swelling degree of 150% or more (average particle diameter: 0.05 μm to 0.5 μm)
Thickener: CMC
Conductive material: CNT
Solvent: water
Current collector: copper foil

Next, using a mixing device, an electrode paste was prepared by mixing a solvent with the active material, the binder, the thickener, and the conductive material at a mass ratio of 95:3.9:1:0.1, resulting in a viscosity of 100,000 mPa·s at a shear rate of 0.1 s⁻¹. Next, using a coating device, the prepared electrode paste was coated onto one surface of a current collector to form a coating film on the current collector.

### 2. Drying

Next, the coating film was dried using a drying device set to a drying temperature of 50° C. to form an electrode layer on the current collector. In this manner, an electrode for evaluation in which an electrode layer was formed on the current collector was obtained.

### Example 2

An electrode for evaluation was obtained by the same method as in Example 1, except that the drying temperature in the drying was changed to 80° C.

An electrode for evaluation was obtained by the same method as in Example 1, except that the drying temperature in the drying was changed to 120° C.

### Comparative Example 1

An electrode for evaluation was obtained by the same method as in Example 1, except that SBR having a swelling degree of less than 150% was used as the binder instead of SAR.

### Comparative Example 2

An evaluation electrode was obtained by the same method as in Example 1, except that SBR having a swelling degree of less than 150% was used as the binder instead of SAR, and the drying temperature in the drying was changed to 80° C.

### Comparative Example 3

An evaluation electrode was obtained by the same method as in Example 1, except that SBR having a swelling degree of less than 150% was used as the binder instead of SAR, and the drying temperature in the drying was changed to 120° C.

### Measurement of Migration Index

For each obtained electrode for evaluation, the migration index K was measured. The migration index K is defined with respect to the electrode layer, where a portion of the electrode layer on a surface side relative to the center in the thickness direction is referred to as a surface-side portion and a portion of the electrode layer on a current collector side is referred to as a current-collector-side portion. In this case, the migration index K is defined as a ratio (K=Bd/Be) of a content concentration Bd of the binder in the surface-side portion to a content concentration Be of the binder in the current-collector-side portion.

The content concentrations Bd, Be of the binder in the surface-side portion and the current-collector-side portion were obtained using a gas chromatography-mass spectrometer (GC-MS). Specifically, first, samples for measuring the amount of binder were produced from a surface-side portion on the surface side and a current-collector-side portion on the current collector side, respectively, of the electrode layer obtained by equally dividing the electrode for evaluation in half along the thickness direction. Next, the content concentrations Bd, Be of the binder in the surface-side portion and the current-collector-side portion were obtained based on the results of quantitatively analyzing the amount of binder contained in the samples produced, using gas chromatography-mass spectrometry (GC-MS).

The closer the migration index K is to 1 (the smaller the migration index K is), the more uniform the distribution of the binder in the electrode layer is. On the other hand, the farther the migration index K is from 1 (the larger the migration index K is), the more unevenly the binder is distributed in the surface-side portion of the electrode layer. The higher the drying temperature during drying of the coating film, the more likely the migration of the binder occurs in the coating film, and thus the migration index K increases.

### Evaluation of Flexibility

For each electrode for evaluation, a bending test was performed according to the test method specified in JIS K 5600-5-1, and the smallest mandrel diameter at which no cracking occurred was obtained. It can be said that the smaller the mandrel diameter, the higher the flexibility.

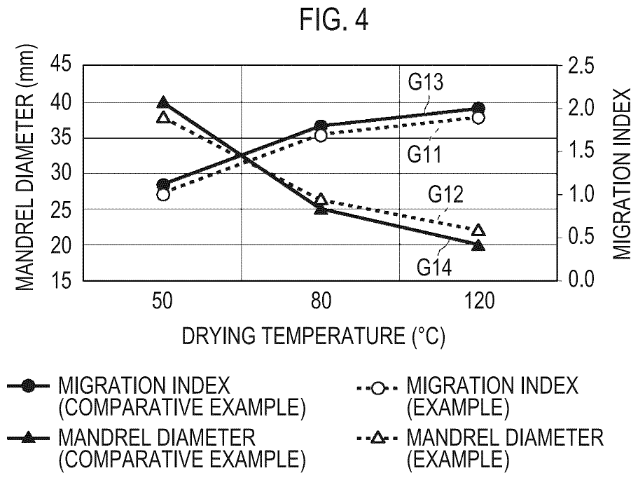

FIG. 4 is a graph showing a relationship between a migration index and a mandrel diameter for each electrode for evaluation. One of the two vertical axes of the graph shown in FIG. 4 indicates the migration index K, and the other indicates the mandrel diameter (mm). A horizontal axis of the graph shown in FIG. 4 indicates the drying temperature (° C.). A broken line graph G11 in FIG. 4 indicates the migration index K for each electrode for evaluation obtained in Examples 1 to 3. A broken line graph G12 in FIG. 4 indicates the mandrel diameter for each electrode for evaluation obtained in Examples 1 to 3. A solid line graph G13 in FIG. 4 indicates the migration index K for the electrodes for evaluation obtained in Comparative Examples 1 to 3. A solid line graph G14 in FIG. 4 indicates the mandrel diameter for each electrode for evaluation obtained in Comparative Examples 1 to 3.

From FIG. 4, it was confirmed that in the cases of Comparative Examples 1 to 3 in which SBR having a swelling degree of less than 150% was used, the larger the migration index K, the higher the flexibility. Similarly, it was confirmed that in the cases of Examples 1 to 3 in which SAR having a swelling degree of 150% or more was used, the larger the migration index K, the higher the flexibility.

### Evaluation of Battery Characteristics

For each electrode for evaluation, tortuosity τ of the electrode layer was obtained using the value of an ion resistance Rᵢₒₙ obtained by measuring the alternating current impedance of the symmetrical model cell. Specifically, first, a symmetrical model cell for measuring the tortuosity was produced using the electrode for evaluation cut into a predetermined shape, a predetermined separator, and a predetermined electrolyte.

Next, the tortuosity τ was calculated based on Expression (1).

Tortuosity τ=(Rᵢₒₙ·A·K·ε)/2d (1)
Rᵢₒₙ: ion resistance
A: electrode area
K: ion conductivity of electrolyte
ε: porosity of electrode layer
d: thickness of electrode layer

The ion resistance Rᵢₒₙ was calculated by measuring the symmetric cell impedance of a symmetric model cell and using the real component at the limiting low frequency of the measured symmetric cell impedance (=ion resistance Rᵢₒₙ/3). The smaller the tortuosity τ, the lower the ion resistance Rᵢₒₙ, and thus it can be said that the battery characteristics are improved.

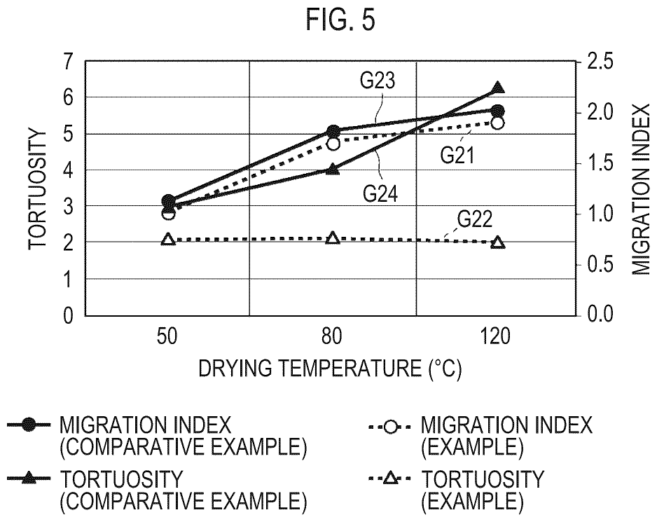

FIG. 5 is a graph showing a relationship between a migration index and tortuosity for each electrode for evaluation. One of the two vertical axes of the graph shown in FIG. 5 indicates the tortuosity, and the other indicates the migration index K. A horizontal axis of the graph shown in FIG. 5 indicates the drying temperature (° C.). A broken line graph G21 in FIG. 5 indicates the migration index K for each electrode for evaluation obtained in Examples 1 to 3. A broken line graph G22 in FIG. 5 indicates the tortuosity for each electrode for evaluation obtained in Examples 1 to 3. A solid line graph G23 in FIG. 5 indicates the migration index K for each electrode for evaluation obtained in Comparative Examples 1 to 3. A solid line graph G24 in FIG. 5 indicates the tortuosity for each electrode for evaluation obtained in Comparative Examples 1 to 3.

From FIG. 5, it was confirmed that in the cases of Comparative Examples 1 to 3 in which SBR having a swelling degree of less than 150% was used, the larger the migration index K, the larger the tortuosity t. On the other hand, it was confirmed that in the cases of Examples 1 to 3 in which SAR having a swelling degree of 150% or more was used, the tortuosity τ was maintained at a level of approximately 2 even in a case where the migration index K was increased.

From these results, it was found that the electrode 1 according to the present disclosure has favorable flexibility due to the binder 21 being unevenly distributed toward the surface 22 side of the electrode layer, and it is possible to suppress deterioration in battery characteristics that may occur due to the uneven distribution of the binder 21 toward the surface 22 side of the electrode layer.

The present disclosure is not limited to the embodiment, and can be appropriately modified without departing from the spirit.

What is claimed is:

1. An electrode comprising:
a current collector; and
an electrode layer provided on the current collector, the electrode layer containing at least a binder having a swelling degree of 150% or more with respect to an active material and an electrolyte,
wherein, when a portion of the electrode layer on a surface side relative to a center of the electrode layer in a thickness direction is defined as a surface-side portion, and a portion of the electrode layer on a current collector side relative to the center of the electrode layer in the thickness direction is defined as a current-collector-side portion,
the electrode layer has a content concentration of the binder in the surface-side portion that is higher than a content concentration of the binder in the current-collector-side portion.

2. The electrode according to claim 1, wherein the binder has a swelling degree of 200% or less.

3. The electrode according to claim 1, wherein the binder has a specific gravity lower than a specific gravity of the active material.

4. The electrode according to claim 1, wherein, when a migration index K indicating an uneven distribution of the binder in the thickness direction in the electrode layer is defined as a ratio (K=Bd/Be) of a content concentration Bd of the binder in the surface-side portion to a content concentration Be of the binder in the current-collector-side portion,
the migration index K is 1.8 or more.

5. A manufacturing method of an electrode, the manufacturing method comprising:
coating, onto a current collector, an electrode paste containing at least a binder having a swelling degree of 150% or more with respect to an active material and an electrolyte to form a coating film on the current collector; and
drying the coating film to form an electrode layer,
wherein, when a portion of the electrode layer on a surface side relative to a center in a thickness direction of the electrode layer is defined as a surface-side portion, and a portion of the electrode layer on a current collector side relative to the center in the thickness direction of the electrode layer is defined as a current-collector-side portion,
in the drying, migration of the binder occurs in the coating film such that a content concentration of the binder in the surface-side portion becomes higher than a content concentration of the binder in the current-collector-side portion.
